(19) United States
(12) Patent Application Publication
(10) Pub. No.: US 2004/0253435 A1
(43) Pub. Date: Dec. 16, 2004

(54) Antibacterial molded resin

(75) Inventor: Makio Nomura, Nagoya-shi (JP)

Correspondence Address: TOWNSEND & BANTA, Suite 900, South Building, 601 Pennsylvania Avenue, N.W., Washington, DC, 20004, US

(73) Assignee: Ishizuka Garasu Kabushiki Kaisha

(21) Appl. No.: 10/459,648

(22) Filed: Jun. 11, 2003

(51) Int. Cl. A01N 25/34

(52) U.S. Cl. 428/327; 428/323; 516/87; 424/404

(57) ABSTRACT

At least a part of the antibacterial agent is distributed in the vicinity of the surface of a resin material. The antibacterial agent preferably contains an inorganic antibacterial agent, and more preferably contains metallic components having the antibacterial property. The metallic components available comprise one or more metals selected from the group of consisting of silver, copper, zinc, iron, gold, platinum, palladium, lead, tin, mercury, cadmium, chromium, nickel and cobalt. The inorganic antibacterial agents comprise one or more substances selected from the group consisting of soluble glass, zirconium phosphate, calcium phosphate, zeolite, silica gel, titanium oxide and porous ceramics.

### BACKGROUND OF THE INVENTION

1. Field of the Invention

The present invention relates to a molded resin having an antibacterial function. In particular, the present invention relates to a molded resin endowed with an antibacterial property by allowing an antibacterial agent to be contained in the resin.

2. Description of the Related Art

With increased interest of keeping clean, people have become to care for hygiene of personal environments. Accordingly, clothes and miscellaneous plastic goods having antibacterial properties have become conspicuous in recent years. While the antibacterial agents used for these goods are roughly divided into organic agents and inorganic agents, the inorganic agents are preferable from the point of safety to human bodies and high heat resistance. Most of the inorganic antibacterial agent comprises metallic compounds exhibiting antibacterial property in some form.

Improvements of performance such as the antibacterial property and durability are required in recent years. The conventional molded resins endowed with the antibacterial performance are not satisfactory, and consequently, an improved molded resin containing antibacterial agents has been desired in the market.

### SUMMARY OF THE INVENTION

The present invention solves the problems as described above to provide an antibacterial molded resin in which the performance such as the antibacterial property and durability are improved.

The present invention for solving the problems above provides a molded resin having an antibacterial function comprising an antibacterial agent at least a part of which is distributed in the vicinity of the surface of the resin material and a part thereof is exposed. Preferably, the antibacterial agent contains at least an inorganic antibacterial agent. The inorganic antibacterial agent may contain at least a metal having an antibacterial property or a compound of the metal having an antibacterial property, and the metal component is one or mole metals selected from the group consisting of silver, copper, zinc, iron, gold, platinum, palladium, lead, tin, mercury, cadmium, chromium, nickel and cobalt. While examples of the inorganic antibacterial agent to be used in the present invention include soluble glass, zirconium phosphate, calcium phosphate, zeolite, silica gel, titanium oxide and porous ceramics, they are not restricted thereto. Preferably, the mean particle diameter of the antibacterial agent is 20 μm or less, and smaller particle size may be accepted depending on uses. The soluble glass composition may contain one or more substances selected from the group consisting of phosphorous, boron and silica, and two or more elements selected from the group consisting of aluminum, zirconium, zinc, magnesium, calcium, barium, strontium, lithium, sodium and potassium. Desirably, the resin of the present invention is either a synthetic polymer or a semi-synthetic polymer.

### DESCRIPTION OF THE PREFERRED EMBODIMENTS

Preferable embodiments of the present invention will be described below.

It is an essential condition that at least a part of the antibacterial agent should be distributed at near the surface of the resin material in the antibacterial molded resin of the present invention, and a part thereof should be exposed on the surface. While inorganic antibacterial agents are preferably used as the antibacterial agent, an organic antibacterial agent may be contained together with the inorganic antibacterial agent when the inorganic antibacterial agent comprises a part of the component. The inorganic antibacterial agent contains metallic components exhibiting an antibacterial property, which may be any forms of metals and metallic compounds. Examples of the metallic component exhibiting the antibacterial property include silver, copper, zinc, iron, gold, platinum, palladium, lead, tin, mercury, cadmium, chromium, nickel and cobalt. Silver, copper and zinc are preferable among them considering safety and high efficiency. Examples of carriers of the metallic component exhibiting the antibacterial property include zeolite and zirconium phosphate which carry the metallic component by ion-exchange process. Silica gel and porous ceramics are examples of the carrier that adsorbs the metallic component by taking advantage of large specific surface area. Glass is an example of the carrier that incorporates the metallic component as one of the composition.

The reasons why the inorganic antibacterial agent carrying metal ions exhibits the antibacterial property are divided in two cases in which the metal ions exhibit the antibacterial property by their catalytic action without dissolving out of the carrier, and in which the metal ions are dissolved to directly exhibit the antibacterial property. The carriers for retaining the metal ions without dissolving the antibacterial agent out of the carrier include zirconium phosphate and zeolite. At least a part of the antibacterial agent should be exposed on the surface for allowing the resin material containing these antibacterial agents to exhibit the antibacterial property.

Examples of the carrier from which the metal ions are dissolved out include glass compositions. The antibacterial metal ion components may be exposed on the surface for allowing the resin material to exhibit the antibacterial property even when the carrier is embedded in the resin. In other words, the antibacterial agent embedded deep into the resin can involve in the antibacterial property in the resin having higher water permeability, while only the antibacterial agent at almost the surface of the resin can involve in the antibacterial property in the resin having lower water permeability. Although it is preferable that at least a part of the antibacterial agent is exposed on the surface, it is not always essential. The resin material containing the antibacterial agent is able to exhibit a sufficient antibacterial property when the antibacterial agent is distributed at least in the vicinity of the surface.

With respect to the amount of the metal ions such as silver and zinc ions dissolved out of the antibacterial resin material, the value of 25×(X+Y) should be more than 12 ng/day per 1 cm² of the surface area of the resin when the amounts of dissolved silver and zinc are expressed by X and Y, respectively. In the measuring method of the metal ions, 1 cc of distilled water is dripped on the surface, a sheet of polyethylene film having an area of 4×4 cm is placed on the water drop, the sample is incubated at 35° C. for 24 hours, and the amounts of silver and zinc are quantitatively analyzed by ICP plasma emission spectrometry.

It is possible to control metal ion dissolution characteristics by changing the components of the glass composition among the inorganic antibacterial agents retaining the metal ions.

Accordingly, the glass composition is preferable since it can cope with requirements such as immediate effects or durability.

The components of the glass composition comprises one or more substances selected from the group consisting of phosphorous, boron and silica, two or more elements selected from the group consisting of aluminum, zirconium, zinc, magnesium, calcium, barium, strontium, lithium, sodium and potassium, and one or more metals exhibiting the antibacterial property selected from the group of consisting of silver, copper, zinc, iron, gold, platinum, palladium, lead, tin, mercury, cadmium, chromium, nickel and cobalt.

The resin material containing the antibacterial agent can be molded by various methods such as extrusion molding, injection molding, coating, adhesion and wet spinning. The antibacterial agent preferably has a mean particle diameter of 20 μm or less considering molding ability and external appearance.

Any resin materials including a synthetic polymer and semi-synthetic polymer may be used as the resin material for adding the antibacterial agent. The synthetic polymer includes synthetic resins such as a phenol resin, melamine resin, epoxy resin, urea resin, unsaturated polyester resin, vinyl chloride resin, polyethylene, polypropylene, polystyrene and polyethylene terephthalate; synthetic rubbers such as polyisoprene and butadiene, and synthetic fibers such as nylon, vinylon, acrylic fiber and rayon. The semi-synthetic fibers include cellulose resin such as cellulose acetate.

### EXAMPLES

### Example 1

The antibacterial agent and resin were kneaded and molded to form the molded resin so that at least a part of the antibacterial agent is exposed from the surface of the resin material as shown in Table 1, and the antibacterial performance of the resin was evaluated. The antibacterial properties were evaluated as O and × when the values of the antibacterial activity were 2.0 or more and less than 2.0 respectively, according to JIS Z 2801:2000. These results are also listed in Table 1.

TABLE 1

| | ANTIBACTERIAL | | Addition | Escherichia | Staphylococcus |
|---|---|---|---|---|---|
| EXAMPLE | AGENT | RESIN | Ratio | coli | aureus |
| EXAMPLE | NOVARON | PP | 0.3 | ∘ | ∘ |
| A | AG300 | | | | |
| EXAMPLE | CIDUPS Z | PP | 0.2 | ∘ | ∘ |
| B | | | | | |
| EXAMPLE | IONPURE P | PP | 0.2 | ∘ | ∘ |
| C | | | | | |
| EXAMPLE | NOVARON | PS | 0.3 | ∘ | ∘ |
| D | AG300 | | | | |
| EXAMPLE | CIDUPS Z | PS | 0.2 | ∘ | ∘ |
| E | | | | | |
| EXAMPLE | IONPURE P | PS | 0.2 | ∘ | ∘ |
| F | | | | | |

Remarks:
* NOVARON AG300: An antibacterial agent containing silver as metal component, product of TOAGOSEI CO., LTD.
* CIDUPS Z: An antibacterial agent as metal component containing silver and zinc, product of NIPPON CHEMICAL
INDUSTRIAL CO., LTD
* IONPURE: An antibacterial agent containing silver as metal component, product of ISHIZUKA GARASU KABUSHIKIKAISHA

### Example 2

For comparing the performance depending on the particle size of the antibacterial agent, the same kind of the antibacterial agent as in Example 1 before pulverizing was ground in a ball mill to mean particle diameters of 5 μm or less, 10 μm or less and 20 μm or less. The pulverized powders were kneaded with a resin in a proportion of 0.5% to prepare test plates so that at least a part of the antibacterial agent is exposed from the surface of the resin material, and the antibacterial properties thereof were measured by the same method as in Example 1. The results are shown in table 2.

TABLE 2

| | | MEAN | | | |
|---|---|---|---|---|---|
| | ANTIBACTERIAL | PARTICLE | | Escherichia | Staphylococcus |
| EXAMPLE | AGENT | SIZE | RESIN | coli | aureus |
| EXAMPLE | IONPURE H | 3 | Unsaturated | ∘ | ∘ |
| K | | | Polyester | | |
| EXAMPLE | IONPURE H | 8 | Unsaturated | ∘ | ∘ |
| L | | | Polyester | | |
| EXAMPLE | IONPURE H | 13 | Unsaturated | ∘ | ∘ |
| M | | | Polyester | | |

Remarks:
* IONPURE H: An antibacterial agent containing silver as metal component, product of TOAGOSEI CO., LTD.

### Example 3

The molded resin was prepared by using various compositions of the soluble glass as the inorganic antibacterial agents so that at least a part of the antibacterial agent is exposed from the surface of the resin material, and the antibacterial properties were measured by the same method as in Example 1. The mean particle diameter of the soluble glass used was adjusted to about 8 μm. Each inorganic antibacterial agent was added to polypropylene (PP) in a proportion of 0.5% by weight to prepare a test plate. The compositions of the inorganic antibacterial agent are shown in Table 3, and the results are shown in Table 4.

TABLE 3

| | EXAMPLE | EXAMPLE | EXAMPLE | EXAMPLE |
|---|---|---|---|---|
| EXAMPLE | U | V | W | X |
| P₂O₅ (mol %) | 5 | 47 | 46 | 40 |
| B₂O₃ (mol %) | 49 | | 5 | 15 |
| SiO₂ (mol %) | 1 | 5 | 4 | |
| Al₂O₃ (mol %) | 1 | 8 | 10 | |
| ZnO (mol %) | | | 34 | |
| MgO (mol %) | 40 | 39 | | 25 |
| CaO (mol %) | | | | 20 |
| Na₂O (mol %) | 4 | 1 | 1 | |
| Ag₂O (wt %) | 1.5 | 1.8 | 0.5 | 1.5 |

TABLE 4

| | Escherichia | Staphylococcus |
|---|---|---|
| EXAMPLE | coli | aureus |
| EXAMPLE U | ◯ | ◯ |
| EXAMPLE V | ◯ | ◯ |
| EXAMPLE W | ◯ | ◯ |
| EXAMPLE X | ◯ | ◯ |

As will be apparent from the descriptions above, the antibacterial molded resin of the present invention is endowed with the antibacterial property without being deprived of the resin's own characteristic while improving the performance and durability over the conventional antibacterial resins, thereby greatly contributing the development of industries.

What is claimed is:

1. A molded resin having an antibacterial function comprising an antibacterial agent at least a part of which is distributed in the vicinity of the surface of the resin material and a part thereof is exposed.

2. The molded resin having an antibacterial function according to claim 1, wherein the antibacterial agent contains at least an inorganic antibacterial agent.

3. The molded resin having an antibacterial function according to claim 2, wherein the inorganic antibacterial agent contains at least a metal having an antibacterial property or a compound of the metal having an antibacterial property.

4. The molded resin having an antibacterial function according to claim 3, wherein the metal component is one or more metals selected from the group consisting of silver, copper, zinc, iron, gold, platinum, palladium, lead, tin, mercury, cadmium, chromium, nickel and cobalt.

5. The molded resin having an antibacterial function according to claims 2, wherein the inorganic antibacterial agent comprises one or more substances selected from the group consisting of soluble glass, zirconium phosphate, calcium phosphate, zeolite, silica gel, titanium oxide and porous ceramics.

6. The molded resin having an antibacterial function according to claims 3, wherein the inorganic antibacterial agent comprises one or more substances selected from the group consisting of soluble glass, zirconium phosphate, calcium phosphate, zeolite, silica gel, titanium oxide and porous ceramics.

7. The molded resin having an antibacterial function according to claims 4, wherein the inorganic antibacterial agent comprises one or more substances selected from the group consisting of soluble glass, zirconium phosphate, calcium phosphate, zeolite, silica gel, titanium oxide and porous ceramics.

8. The molded resin having an antibacterial function according to any one of claims 1, wherein the mean particle diameter of the antibacterial agent is 20 μm or less.

9. The molded resin having an antibacterial function according to claim 5, wherein the soluble glass composition contains one or more substances selected from the group consisting of phosphorous, boron and silica, and two or more elements selected from the group consisting of aluminum, zirconium, zinc, magnesium, calcium, barium, strontium, lithium sodium and potassium.

10. The molded resin having an antibacterial function according to any one of claims 1, wherein the resin is either a synthetic polymer or a semi-synthetic polymer.
